(19) United States
(12) Patent Application Publication
(10) Pub. No.: US 2008/0193688 A1
(43) Pub. Date: Aug. 14, 2008

(54) Device And Method For Manufacturing Wrapped Tubes

(76) Inventors: Karl-Heinz Krah, Daaden (DE); Adolf Berger, Lohmar-Heide (DE)

Correspondence Address: Vincent L. Ramik;Diller, Ramik & Wight, 7345 McWhorter Place;, Suite 101, Annandale, VA, 22003, US

(21) Appl. No.: 10/581,929

(22) PCT Filed: Nov. 9, 2004
(86) PCT No.: PCT/EP04/12649

§ 371 Date: Apr. 10, 2007

(30) Foreign Application Priority Data
Nov. 24, 2003 (DE) 103 55 073.9

(51) Int. Cl. B28B 21/72; B29D 23/00; B32B 1/08

(52) U.S. Cl. 428/34.5; 425/66; 264/258; 428/36.4

(57) ABSTRACT

In a device and a method for manufacturing wrapped tubes by helically winding up a thermoplastic, preferably strip-shaped plastic profile (2) onto a winding core (1) in an overlapping manner, where a plasticizing aggregate supplies the plastic profile (2) via a profile nozzle (4), it is provided that the plasticizing aggregate is a kneading means (3) supplying a thermoplastic plastic mixed with reinforcing fibers to the winding core (1) via the profile nozzle (4).

### BACKGROUND OF THE INVENTION

1. Field of the Invention

The invention relates to a device as well as a method for manufacturing wrapped tubes by helically winding up a thermoplastic, preferably strip-shaped plastic profile onto a winding core in an overlapping manner, a plasticizing aggregate supplying the plastic profile via a profile nozzle.

2. Description of Related Art

Devices for manufacturing a tubular object by helically or spirally winding up a band material of thermoplastic plastics are known, for example, from DE-AS 1281676. Immediately after the band material has emerged from an extruder or has been heated, it is wound up, in a deformable state, onto a winding core with an overlapping and/or abutting, particularly obliquely abutting overlapping winding seam and welded by applying pressure and, if necessary, additional heat in the region of the winding seam in such a method.

### SUMMARY OF THE INVENTION

It is the object of the invention to provide a device as well as a method for manufacturing wrapped tubes by which pressure tubes with a larger tube diameter are producible without an extreme enlargement of the wall thickness as would be the case in the present wrapped tube production.

This object is solved by the features of claim 1.

The invention advantageously provides that the plasticizing aggregate is a kneading means supplying the winding core with a thermoplastic plastic mixed with reinforcing fibers via the profile nozzle.

Because of the use of a screw kneading aggregate, reinforcing fibers with greater fiber lengths can also be mixed homogeneously with the thermoplastic plastic without shortening or grinding the fibers. The screw kneading aggregate permits the exactly metered addition of fibers into the processed molten mass, the fiber length of the added fibers being preserved. The increase in pressure-resistance and tensile strength due to the fiber strengthening permits to manufacture, e.g., larger tube diameters with a tube wall of lesser wall thickness and thus of small weight. Due to the strengthening, pressure tubes with an outer diameter of, e.g., up to 4 m and more are producible as wrapped tubes.

Such a homogenized mixture of fibers and thermoplastic plastic while preserving the fiber length of the fibers cannot be produced by a conventional extruder because of the very high shearing forces, since the fibers are shortened and ground due to the occurring shearing forces.

Preferably, the thermoplastic plastic consists of polyethylene or polypropylene. No granules with fillers are used but polyethylene granules or polypropylene granules are plasticized in the kneader and provided with fiber-shaped reinforcing agents, in principle, all strength-increasing reinforcing fibers being suitable.

Preferably, the reinforcing fibers consist of plastic, glass and/or metal, glass fibers in particular, but also aramide fibers and/or carbon fibers being highly strength-increasing.

When several layers of the plastic profile are wound up, this is effected under a different supply angle so that the fiber-reinforced superposed winding layers cross each other whereby the internal pressure resistance of the wrapped tubes is additionally increased.

On the outside of the wrapped tube, a profile, preferably a tube profile, may be additionally wound onto the outer tube wall to increase the tube stiffness and the moment of inertia.

The fiber length of the reinforcing fibers amounts to at least about 2 mm, but preferably to more than 4 mm up to endless fibers.

The screw kneading aggregate is adapted to process such fiber lengths up to endless fibers.

The fiber-reinforced thermoplastic mixture homogenized in the screw kneader consists of about 60 to about 94 percent by weight of polyethylene or polypropylene, about 1 to about 10% of the bonding agent as well as of about 5 to about 40 percent by weight of reinforcing fibers arranged in an uniformly distributed manner in random orientation in the plastic profile.

The bonding agent particularly serves to improve the adhesion between the polyethylene or polypropylene and the fibers.

In addition to the at least one layer formed of the fiber-reinforced plastic profiles, an innermost and/or an outermost winding layer of polyethylene without fiber reinforcement may also be wound up onto the winding core.

Hereinafter, an embodiment of the invention is explained with reference to the drawings.

### BRIEF DESCRIPTION OF THE DRAWINGS

FIG. 1 shows, in side view, a device according to the invention, for manufacturing wrapped tubes.

FIG. 2 shows the device according to FIG. 1 in top view.

FIG. 3 shows the winding of several winding layers.

### DETAILED DESCRIPTION OF THE PREFERRED EMBODIMENTS OF THE INVENTION

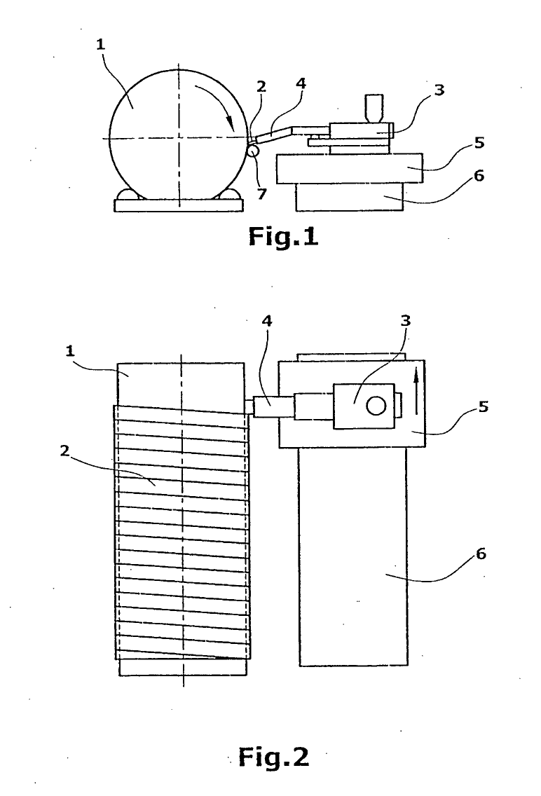

FIG. 1 shows a device for manufacturing a wrapped tube by helically winding up a thermoplastic, preferably strip-shaped plastic profile 2 onto a temperable or heatable winding core 1 in an overlapping manner.

A screw kneading aggregate 3 used for plasticizing is seated on a reciprocating slide 5 that is adapted to be displaced to and fro along a guide 6 parallel to the winding core 1, the plastic profile 2 being supplied to the winding core 1 from the screw kneading aggregate 3 via a profile nozzle 4.

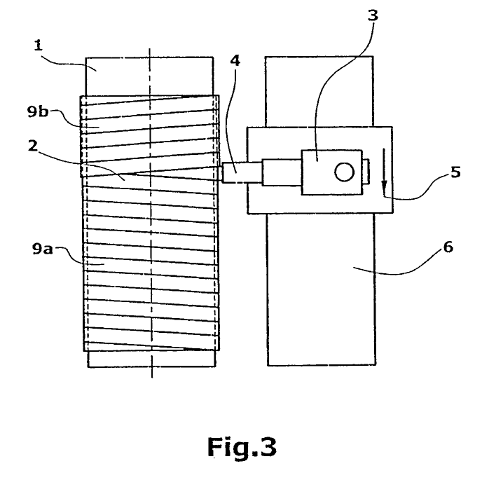

As can be seen from the top view of FIG. 2, the plastic profile 2 is supplied to the winding core 1 via the profile nozzle 4 under an oblique angle. In the reversal position of the slide 5 at the ends of the winding core 1, there arises an oblique angle with the same amount but with opposite direction because of the reversal of the direction of movement of the slide 5 so that succeeding winding layers 9a, 9b cross each other. Preferably, it is provided that the start of a new winding layer is respectively effected at different ends of the winding core 1 so that the winding process can substantially be continued continuously. The first plastic profile 2 of a winding layer may also be supplied straight to obtain a straight end at the end faces of the wrapped tube. From FIG. 3, the different orientation of the plastic profile 2 of superposed winding layers 9a, 9b is apparent.

While the slide is thus moved to and fro, the winding core 1 rotates to wind up the strip-shaped plastic profile 2 in an overlapping manner, which profile is welded at the points of overlapping and abutment.

The screw kneading aggregate 3 supplies a homogenized mixture of a thermoplastic plastic of polyethylene or polypropylene and reinforcing fibers of plastic, glass and/or metal to the profile nozzle 4. Upon emerging from the double screw kneader, the fibers are arranged in the mixture so as to be distributed homogeneously in random orientation in the thermoplastic plastic and then, they are supplied to the winding core 1 via the profile nozzle 4.

Preferably, the screw kneading aggregate consists of a double screw kneader where the screws arranged in parallel next to each other do not rotate in opposite directions but have the same rotational direction. The kneading means is also referred to as double screw kneader with the same rotational direction. In dependence on the processed mixture, the temperature of the thermoplastic plastic amounts to about 170 to 240° C.

Single-screw as well as double screw extruders rotating in opposite directions, however, are not suited to produce the mixture of fiber-reinforced fibers and thermoplastic plastic because they do not have a sufficient homogenizing effect and shorten or grind the fibers because of the occurring shearing forces so that the pressure resistance required for the production of pressure-resistant wrapped tubes with large diameter cannot be achieved.

Preferably, reinforcing fibers of glass fibers are employed, for particular applications and particularly high strength requirements, however, aramide fibers and/or carbon fibers or a mixture of different fibers can be used as well.

The fiber length should amount to at least 2 mm, preferably, however, to more than 4 mm. In a preferred embodiment, the fiber length amounts to about 6 mm. It is also possible, however, to use longer fibers up to endless fibers.

The fiber-reinforced thermoplastic plastic mixture emerging from the screw kneader 3 preferably consists of about 60 to about 94 percent by weight of polyethylene or polypropylene, about 1 to about 10% of bonding agent as well as of about 5 to about 40 percent by weight of reinforcing fibers.

Therefore, a double screw kneader 3 is used as a plasticizing aggregate for manufacturing wrapped tubes with an increased internal pressure resistance, a thermoplastic plastic being brought to a predetermined melting temperature in the double screw kneader 3 and then being homogeneously mixed with reinforcing fibers. Subsequently, the fiber-reinforced homogenized thermoplastic plastic mixture can be supplied to the profile nozzle 4.

As a whole, the wrapped tube may be formed of several winding layers, where the innermost and/or the outermost winding layer may be formed of polyethylene without fiber reinforcement. Preferably, the fiber-reinforced winding layers are wound crosswise, i.e., radially adjacent winding layers 9a, 9b extend under different angles such that the orientation of the fibers crosses each other in the individual winding layers.

By means of the described device and the manufacturing method, wrapped pressure tubes with large dimensions and very high internal pressure resistance are producible, the wall thickness, due to the fiber reinforcement, being substantially, i.e., by about 50%, smaller than with conventional manufacturing methods without fiber reinforcement.

In a wrapped tube with a diameter of about 4 m, for example, the wall thickness amounts to about 100 mm to 200 mm, each winding layer 9a, 9b being formed of a plastic profile 2 with a thickness of about 5 to 10 mm. Such pressure-resistant wrapped tubes are suitable for the conveyance of drinking water, for example.

As is apparent from FIG. 1, the winding core 1 rotates clockwise so that the plastic profile 2 is wound downward onto the winding core 1, a pressing means 7 pressing the plastic profile 2 against the winding core 1. The screw kneader 3 extends under an angle of 90° to the longitudinal axis of the winding core 1, the oblique angle of each winding layer 9,11 resulting solely from the advance of the slide 5.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A device for manufacturing wrapped tubes by helically winding up a thermoplastic, preferably strip-shaped plastic profile (2) onto a winding core (1), a plasticizing aggregate supplying the plastic profile (2) to the winding core (1) via a profile nozzle (4),
characterized in
that the plasticizing aggregate is a kneading means (3) supplying a thermoplastic plastic mixed with reinforcing fibers via the profile nozzle (4).

2. The device according to claim 1, characterized in that the kneading means is a screw kneading aggregate.

3. The device according to claim 1, characterized in that the thermoplastic plastic consists of polyethylene or polypropylene.

4. The device according to claim 1 characterized in that the reinforcing fibers consist of plastic, glass and/or metal.

5. The device according to claim 3, characterized in that the reinforcing fibers consist of glass fibers, aramide fibers and/or carbon fibers.

6. The device according to claim 4, characterized in that the fiber length of the reinforcing fibers amounts to at least 2 mm, preferably to more than 4 mm up to endless.

7. The device according to claim 1, characterized in that the wrapped tube consists of several superposed winding layers (9a, 9b) formed of the plastic profile (2) and extending under an oblique angle relative to each other.

8. The device according to claim 1, characterized in that the fiber-reinforced mixture homogenized in the kneading means (3) consists of
60 to 94 percent by weight of polyethylene or polypropylene
1 to 10 percent by weight of bonding agent as well as
5 to 40 percent by weight of reinforcing fibers.

9. A method for manufacturing wrapped tubes by winding up a thermoplastic, preferably strip-shaped plastic profile (2) onto a winding core (1) in an overlapping manner, the plastic profile (2) being supplied to the winding core (1) from a plasticizing aggregate and a profile nozzle (4),
characterized in
that a kneading means (3) is employed as a plasticizing aggregate for manufacturing wrapped tubes with an increased internal pressure resistance,
and that a thermoplastic plastic is brought to a predetermined melting temperature and homogeneously mixed with reinforcing fibers in the screw kneader (3),
the fiber-reinforced homogenized thermoplastic plastic mixture being subsequently supplied to the winding core (1) via the profile nozzle (4).

10. The method according to claim 9, characterized in that polyethylene or polypropylene is used as thermoplastic plastic.

11. The method according to claim 7, characterized in that reinforcing fibers of plastic, glass and/or metal are used.

12. The method according to claim 9, characterized in that the wrapped tube is formed of several winding layers (9a, 9b) wrapped on top of each other.

13. The method according to claim 12, characterized in that the plastic profile (2) is supplied to the winding core (1) under a predetermined oblique angle.

14. The method according to claim 12, characterized in that the several winding layers (9a, 9b) are wound up continuously and that at the reversal positions at the ends of the winding core (1), the oblique angle changes to a different oblique angle with opposite direction due to the reversal of the winding direction in such a manner that succeeding winding layers (9a, 9b) cross each other.

15. The method according to claim 12, characterized in that the innermost and/or the outermost winding layer is wound of polyethylene without any fiber reinforcement.

16. A wrapped tube manufactured according to the method according to claim 9, characterized in that it consists of a fiber-reinforced homogeneous mixture of
60 to 94 percent by weight of polyethylene or polypropylene
1 to 10 percent by weight of bonding agent as well as
5 to 40 percent by weight of reinforcing fibers arranged in random orientation.

17. The device according to claim 2, characterized in that the thermoplastic plastic consists of polyethylene or polypropylene.

18. The device according to claim 5, characterized in that the fiber length of the reinforcing fibers amounts to at least 2 mm, preferably to more than 4 mm up to endless.

19. The method according to claim 8, characterized in that reinforcing fibers of plastic, glass and/or metal are used.

20. The method according to claim 13, characterized in that the several winding layers (9a, 9b) are wound up continuously and that at the reversal positions at the ends of the winding core (1), the oblique angle changes to a different oblique angle with opposite direction due to the reversal of the winding direction in such a manner that succeeding winding layers (9a, 9b) cross each other.
